(19) United States
(12) Patent Application Publication
(10) Pub. No.: US 2014/0365900 A1
(43) Pub. Date: Dec. 11, 2014

(54) REPLICATION OF MOBILE RENDERING USING COMPUTER-READABLE IMAGES

(71) Applicants: Brian Chu, San Mateo, CA (US); Christina Kuhn Greer, Mountain View, CA (US)

(72) Inventors: Brian Chu, San Mateo, CA (US); Christina Kuhn Greer, Mountain View, CA (US)

(73) Assignee: GOOGLE INC., Mountain View, CA (US)

(21) Appl. No.: 13/436,733

(22) Filed: Mar. 30, 2012

Related U.S. Application Data
(60) Provisional application No. 61/470,304, filed on Mar. 31, 2011.

(51) Int. Cl. G06F 3/01; G06F 15/16

(52) U.S. Cl. 715/738

(57) ABSTRACT

An example device includes one or more processors configured to generate for display, data corresponding to a selectable control, the computing device provides a pre-production web application, the selectable control is displayable in association with output of the pre-production web application, and the selectable control, when selected, causes a computer-readable image encoding a uniform resource identifier (URI) associated with the pre-production web application to be generated, to receive a selection of the selectable control, identify the URI, and generate for display the computer-readable image, where the computer-readable image is displayable to a mobile computing device, use the computer-readable image to obtain the URI, make a request to the pre-production web application using the URI, and display the output, receive, from the mobile computing device, the request, and provide to the mobile computing device, the output, such that the mobile computing device displays the output of the pre-production web.

This application claims the benefit of U.S. Provisional Patent Application No. 61/470,304, filed Mar. 31, 2011, which is hereby incorporated by reference in its entirety.

### TECHNICAL FIELD

This disclosure relates to replication of rendering by mobile computing devices.

### BACKGROUND

Users of mobile computing devices often utilize versions of applications designed specifically for mobile platforms. The mobile versions of the applications may be similar in some ways to the versions designed for non-mobile platforms, but may differ in design to accommodate the difference in the operating systems and the environments in which the applications function.

### SUMMARY

In general, this disclosure describes techniques that may potentially allow developers of applications for mobile computing devices to more easily test applications or portions of applications during development. Applications or portions of applications may be encoded using a computer-generated image. These techniques may allow scanning and decoding the computer-generated image by a mobile computing device, and provide a developer with the ability to test specific portions directly on the mobile computing device and the specific operating system and platform associated with the mobile computing device. In this manner, a developer may be able to more easily and accurately test applications or portions of applications, without compromising security or downloading an entire application onto the mobile computing device.

In one example, the disclosure is directed to a method that includes generating for display, by at least one computing device, data corresponding to a selectable control, wherein the at least one computing device provides a pre-production web application that is at a pre-production stage of development, the selectable control is displayable in associated with output of the pre-production web application, and the selectable control, when selected, causes a computer readable image encoding a uniform resource identifier (URI) associated with the pre-production web application to be generated. The method further includes receiving a selection of the selectable control, identifying a URI associated with the pre-production web application, and generating for display a computer-readable image encoding the URI. The computer-readable image is displayable to a mobile computing device configured to capture the computer-readable image, use the computer-readable image to obtain the URI, make a request to the pre-production web application using the URI, and display output of the pre-production web application, the output corresponding to the URI. The method further includes receiving, by the at least one computing device and from the mobile computing device, a request using the URI, the mobile computing device having previously captured and used the computer-readable image to obtain the URI, and responsive to the request, providing, by the at least one computing device and to the mobile computing device, output of the pre-production web application corresponding to the URI, such that the mobile computing device displays the output of the pre-production web application corresponding to the URI.

In another example, the disclosure is directed to a computer-readable storage medium encoded with instructions that, when executed, cause one or more processors to perform operations. The operations include receiving, by the at least one computing device, data including a uniform resource identifier (URI) associated with a pre-production web application, wherein the pre-production web application is at a pre-production stage of development, and generating for display a computer-readable image encoding the URI that is displayable to a mobile computing device configured to capture the computer-readable image to obtain the URI, make a request to the pre-production web application using the URI, and display output of the pre-production web application, the output corresponding to the URI. The operations further include receiving, by the at least one computing device and from the mobile computing device, a request using the URI, the mobile computing device having previously captured and used the computer-readable image to obtain the URI. The operations further include responsive to the request, providing, by the at least one computing device and to the mobile computing device, output of the pre-production web application corresponding to the URI, such that the mobile computing device displays the output of the pre-production web application corresponding to the URI. In another example, the disclosure is directed to a computing device including one or more processors, and a display device. The one or more processors are configured to generate for display, data corresponding to a selectable control, where the computing device provides a pre-production web application that is at a pre-production stage of development, the selectable control is displayable in association with output of the pre-production web application, and the selectable control, when selected, causes a computer-readable image encoding a uniform resource identifier (URI) associated with the pre-production web application to be generated. The one or more processors are further configured to receive a selection of the selectable control, identify a URI associated with the pre-production web application, and to generate for display a computer-readable image encoding the URI, where the computer-readable image is displayable to a mobile computing device configured to capture the computer-readable image, use the computer-readable image to obtain the URI, make a request to the pre-production web application using the URI, and display output of the pre-production web application, the output corresponding to the URI. The one or more processors are further configured to receive, from the mobile computing device, request using the URI, the mobile computing device having previously captured and used the computer-readable image to obtain the URI, and to provide, responsive to the request, and to the mobile computing device, output of the pre-production web application corresponding to the URI, such that the mobile computing device displays the output of the pre-production web application corresponding to the URI.

The techniques of this disclosure may provide one or more advantages. For example, a developer may send copies of the same computer-readable message to several mobile devices having different hardware and/or running different operating systems, platforms, application software, etc. The developer may send copies of the application (e.g., a web application) at a pre-production stage of development. A pre-production web application may include data or other information related to the web application prior to the developer making the web application accessible as a finished product (e.g., in a production environment). The developer may then compare how the application is rendered by each different mobile device. As another example, certain techniques may allow a developer of an application for mobile computing devices to easily test the mobile application or portions of the application on mobile computing devices directly, without requiring connectivity or compromising transmission security of proprietary software. Applications or portions of the applications may be encoded in a computer-generated image which is also computer-readable, and which may be scanned by a mobile computing device. Scanning the computer-generated image by the mobile computing device may result in allowing the developer of the application to observe the behavior of the application or the portion of the application being tested directly on the mobile computing device to determine whether the application is behaving according to its intended purpose and design.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system in accordance with techniques of this disclosure.

FIGS. 2A-2B illustrate example screens of a mobile computing device as a user interacts with the device, in accordance with one or more techniques of the present disclosure.

FIG. 3 is a block diagram illustrating further details of one example of the computing device shown in FIG. 1.

FIG. 4 is a block diagram illustrating further details of one example of the mobile computing device shown in FIGS. 2A-2B.

FIG. 5 is a flow diagram illustrating an example method that may be performed by a computing device in accordance with one or more techniques of the present disclosure.

### DETAILED DESCRIPTION

In general, this disclosure describes techniques that may potentially allow developers of applications for mobile computing devices to more easily and efficiently test applications or portions of applications during development. Applications or portions of applications may be encoded using a computer-generated image. These techniques may allow scanning and decoding of the computer-generated image by a mobile computing device, and provide a developer with the ability to test specific portions directly on the mobile computing device and the specific operating system and platform associated with the mobile computing device. In this manner, a developer may be able to more easily and accurately test applications or portions of applications, without compromising security or downloading the entire application onto the mobile computing device.

During the development stages of applications for mobile computing devices, such as native applications and/or web-based applications, development of the applications often takes place in a non-mobile environment (e.g., a desktop computer or a workstation). Often, difficulties may arise during the testing phase when a developer of a mobile application wants to test the functionality of the mobile applications or portions thereof, e.g., web elements within a website. For example, developed code or software may be tested on a desktop or workstation computer using such tools as an emulator program. However, this testing may be limited in scope as it may not accurately emulate or reflect how the content will behave in a mobile environment.

Additionally, several native applications and web-based applications often differ from one mobile computing device to another based on the size of the display, the operating system, and/or the browser used on a mobile computing device. Most, and sometimes all, of these factors may prove challenging to reproduce and duplicate on other types of computing devices (e.g., desktop computer or a workstation), therefore, difficulties may arise in ensuring applications behave consistently in different target environments. Additionally, for certain applications, such as certain web-based applications, the response or outcome of launching the application during testing may be non-deterministic, e.g., every time a web page loads, a different image is displayed in the header or a different product is featured. Testing on an emulator or on the non-mobile environment may require a developer to refresh the application until the desired response or outcome is acquired, which may make the testing process inefficient and tedious.

As a result, it may be desirable to perform testing directly on mobile computing devices. In one example, an applications or a portion of application being tested may be communicated to the mobile computing device. Additionally, it may be desirable to test one outcome or response of an application (e.g., one of images or featured products on a web page that changes every time the web page is refreshed). However, during the development stage, an application under development may be stored on a secure network, which may not be accessible or may not provide permissions allowing any portions of developed code to be communicated or transmitted outside an internal network. Therefore, accessing developed code or software via the mobile computing device and directly from the network becomes difficult. One way to test web-based applications on mobile devices has been to send a link of the developed content to the mobile device, and opening the link on the mobile device to determine whether the content behaves as expected in the mobile environment. However, in addition to being time-consuming, this process requires connectivity, which is not always readily available.

The techniques of this disclosure take advantage of the ability of computing devices to scan computer-generated images. For example, most current mobile devices incorporate cameras that may be used to capture an image, such as a computer-generated image. A mobile device may also be capable of utilizing applications that translate the image of the computer-generated image into the information encoded therein. As a result, testing applications or portions of applications directly on a mobile computing device may become more efficient and secure than testing applications using an emulator running on a different operating system or trying to communicate the applications over communication channels for testing purposes.

In one implementation, computer-generated images are barcodes, which are computer-generated images that encode data and are computer-readable. In some examples, an optical scanner may be utilized to read computer-generated images and decode the scanned image to obtain a decoded version of the data, e.g., text, product information, contact information, website address, and the like.

In some examples, barcodes may be linear or 1-dimensional images, which represent data in terms of parallel lines and spacing between the parallel lines. A universal product code (UPC) is one example of linear or 1-dimensional barcodes, and is widely used to track items, usually in stores. The UPC encodes 12 digits as alternating bars and spaces with varying widths. In retail, each digit may have a specific meaning based on location and value, indicating such things as the type of products, country of origin, and price, for example.

In other examples, barcodes may be matrix codes or 2-dimensional images, which represent data in any one of a multitude of shapes such as squares, dots, hexagons, and other geometric patterns. Matrix codes or 2-dimensional barcodes are similar to linear or 1-dimensional barcodes, but have greater data representation capabilities. PDF417, Quick Response (QR) code, and Aztec code are some examples of 2-dimensional barcodes. For example, a PDF417 barcode consists of 3 to 90 rows, each of which is a linear barcode. As another example, an Aztec code is a symbol built on a square grid with a bulls-eye pattern in the center, and data is encoded in concentric square rings around the bulls-eye pattern.

A QR code is a symbol built on a square grid with three corner square patterns that define its position. QR codes are widely used to encode a variety of information, and QR code generation websites are publicly available. Users with a computing device equipped with a camera and a reader application can capture an image of the QR code using the camera and decode the QR code using the reader application. In one example, the QR code may encode a universal resource locator (URL), and upon scanning the QR code, the reader application may decode the code and cause the launching of a browser and redirecting to the encoded URL. In another example, the QR code may encode markup language associated with a web element, and upon scanning the QR code, the reader application may decode the code and cause the display of the encoded web element. While this disclosure discusses using QR codes, it should be understood that the techniques of this disclosure are applicable to other types of computer-generated images and barcodes. Additionally, while examples of this disclosure discuss web applications, it should be understood that the techniques discussed herein are applicable to other types of applications as well, such as mobile applications, including native applications.

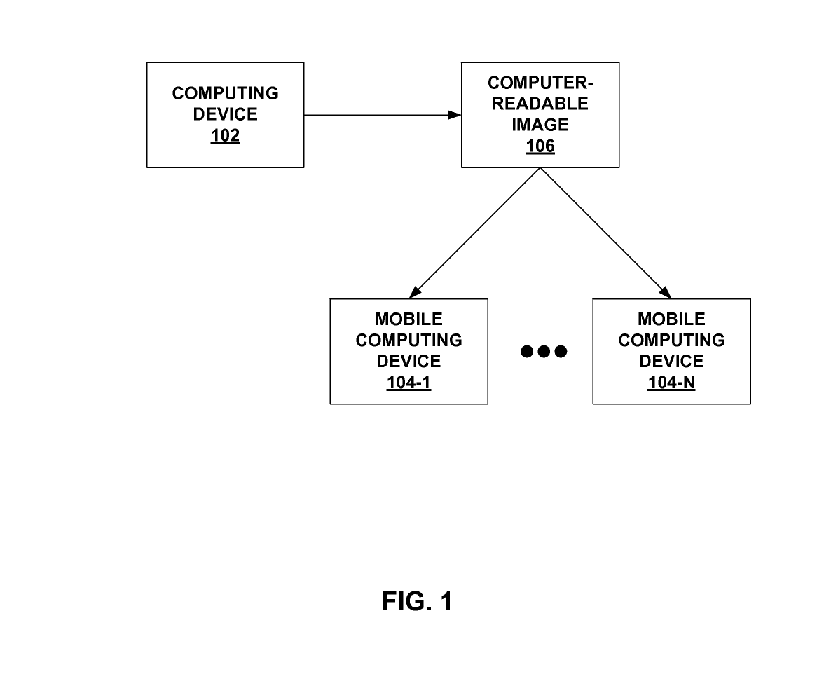

FIG. 1 is a block diagram illustrating an example system in accordance with techniques of this disclosure. In the example of FIG. 1, the system includes computing device 102, and mobile computing devices 104-1 to 104-N (hereinafter, mobile computing devices 104). Computing device 102 may be a desktop computer, a workstation, or any other type of computing device that an application developer may utilize to develop an application for computing devices. The developer may utilize computing device 102 to develop different versions of the application such as, for example, versions for mobile platforms and operating systems.

During development of certain applications, for example, web-based applications or applications that incorporate web-based elements, a developer may wish to test mobile rendering of the web-based elements of an application on mobile computing devices. A developer may be able to utilize an emulator to duplicate a mobile browser or environment on computing device 102. However, mobile browsers and environments vary greatly from one type of device to another, and desktop emulators may not be able to provide a true testing environment. Therefore, it may be desirable to test the developed applications directly on mobile computing devices. However, due to security issues (e.g., protection of proprietary information, fear of hacking, and the like), the developer may not be able to communicate the coded elements to a mobile device for testing. Additionally, attempting to directly enter the code on the mobile computing devices may be tedious and difficult, due to limitations of keyboards of mobile computing devices, and limited processing capabilities, including the ability to compile and run code.

In accordance with techniques of this disclosure, a developer of an application may develop portions or elements of an application that he/she wishes to test in one or more mobile environments. The developer may generate a computer-readable image 106 (e.g., a QR code) that encodes the portion of the application under testing. In one example, computer-readable image 106 may encode a link associated with the application or portion of the application such as, for example, a web-based application which may contain web-based elements represented by links (e.g., URLs). In another example, computer-readable image 106 may encode the code for the application or portion of the application, e.g., the markup language of the element under testing. Techniques of this disclosure may also utilize advantages of visual forms of communication (e.g., QR codes) to offset possible vulnerabilities related to relying on electronic forms of communication (e.g., cellular networks).

Computer-readable image 106 may be generated, for example, using any one of many available websites that generate computer-readable images. Computer-readable image 106 may be generated by entering the text (e.g., the URL or code) that a user desires to convert to QR-code, for example, and the corresponding image is generated. In one example, the developer may enter the URL or code for the application as text into a computer-readable image generator and obtain, in response, a computer-generated image that is also computer-readable (e.g., QR code). The developer may print the generated image, display the image on a display, such as a screen or monitor associated with computing device 102, or store the image electronically (e.g., on a flash drive, hard drive, etc.).

In one example, the developer may then utilize computer-readable image 106 to test the applications or portions of the application encoded in computer-readable image 106 on one or more of mobile computing devices 104. Mobile computing devices 104 may include, be, or be part of for example, a mobile phone (including smartphones), tablet computer, personal digital assistant (PDA), and watch, among. In one example, mobile computing devices 104 may be equipped to scan computer-generated images and decode them.

In one example, mobile computing device 104-1 may have one or more image captures device (e.g., camera) that can be utilized to capture an image of computer-generated image 106. Mobile computing device 104-1 may also include a reader application that launches upon capturing and scanning of the computer-generated image. The reader application may decode the scanned image and determine, based on the information contained in the computer-generated image, what to do next. For example, the information in computer-readable image 106 may be a URL of the application element being tested and may cause the reader application to launch a web browser to display the URL. In another example, the information in computer-readable image 106 may be a markup language representing the application element being tested and may cause the reader application to load the markup language into the appropriate mobile application, e.g., a browser. Examples of markup languages that may be used in accordance with the techniques of this disclosure may include the hypertext markup language (HTML), the extensible markup language (XML), and others.

In one example, to minimize computation resource requirements and library dependencies from the server on which the application is developed, and to properly present computer-generated image 106, the server may internally generate the information necessary to render the computer-generated image as an image and map the information into another format (e.g., JavaScript snippet, HTML, CSS, text, images or other types of media, and the like). In one example, mapping of the information may be utilized when the desired output contains multiple forms, i.e., information in multiple formats. In one example, mapping the information from the multiple formats to one format allows generating computer-generated image 106 to encapsulate all the forms together.

In one example, mobile computing device 104 may not be equipped with an image capture device, may not support reading computer-generated images, or the image capture device may not be functioning. In this example, mobile computing device 104 may be tailored to receive information representing the information encoded in computer-readable image 106 using the available software and/or hardware on mobile computing device 104. For example, mobile computing device 104 may receive the encoded information using near-field communication (NFC), memory media (e.g., secure digital (SD) cards, other removable/pluggable memory media), manual input (e.g., typing in an associated URL), physical tethering (e.g., where mobile computing device 104 is connected to computing device 102 via a wired interface), over shared Wi-Fi, and the like.

In one example, where mobile computing device 104 is equipped with an image capture device, the reader application may automatically launch the appropriate application associated with the information encoded in computer-readable image 106. The developer may not be required to do anything other than capture computer-readable image 106 by directing the mobile computing device's image capture device such that computer-readable image 106 is scanned.

In one example, each of mobile computing devices 104 may differ from the other mobile computing devices, e.g., each of mobile computing devices 104 may be manufactured by a different company, each of mobile computing devices 104 may run a different operating system, each of mobile computing devices 104 may utilize different platforms for running the same type of application (e.g., different browsers), and the like. Using the techniques of this disclosure, an application or a portion of the application may be efficiently and easily deployed and tested across different platforms, environments, operation systems, and the like. For example, for a web-based element that a developer wishes to test, mobile rendering of the web-based element may be tested on several of mobile computing devices 104 using a single computer-readable image 106 associated with the web-based element. Additionally, the developer may easily test compatibility of applications on as many different types of mobile computing devices, different platforms, and different operating systems as possible.

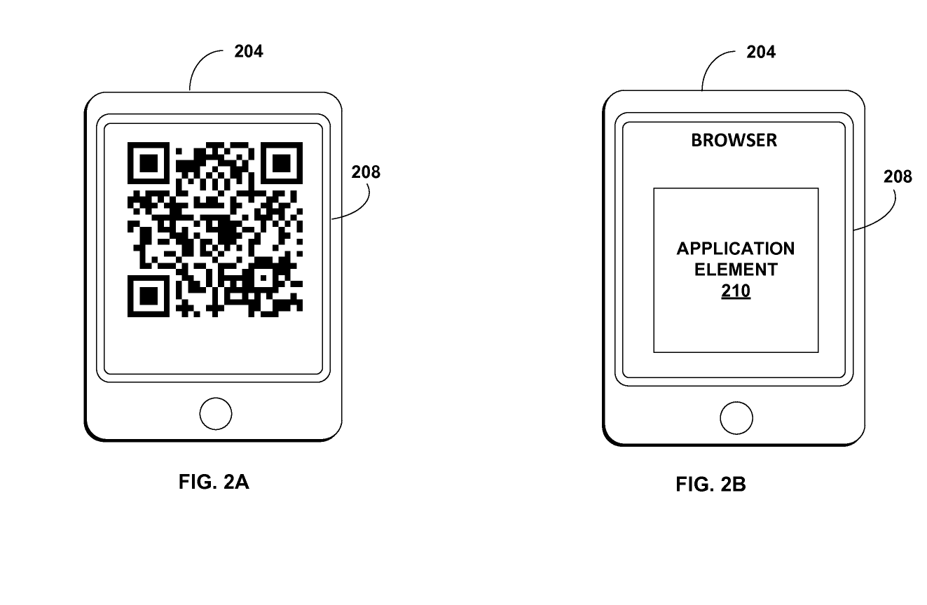

FIGS. 2A-2B illustrate example screens of a mobile computing device as a user interacts with the device, in accordance with one or more techniques of the present disclosure. As discussed above, an application developer may obtain a computer-generated image (e.g., computer-readable image 106) that encodes an application or an element of the application to be tested. The encoded application or element of the application may be developed on a computing device (e.g., computing device 102) and may be intended for mobile computing devices.

The developer (or user) may wish to test the application or element of the application on mobile computing devices to determine compatibility and functionality. For example, for web-based applications, the developer may wish to determine whether an application is displayed properly in a browser on a mobile computing device, whether associated links function properly, and the like. Additionally, the developer may wish to test the behavior of the application or the element on different types of mobile computing devices, different platforms (e.g., browsers), or different mobile operating systems, for example.

In one example, as FIG. 2A shows, the developer may utilize mobile computing device 204 to scan the computer-generated image generated by the computing device on which the application is developed. Mobile computing device 204 may be equipped with an image capture device (e.g., camera, built in scanner, infrared sensor, NFC reader, or the like) that the user (e.g., a developer) may operate to capture an image of the computer-generated image. Mobile computing device 204 may be, for example, a mobile phone (including smartphones), tablet computer, PDA, or the like, and may have a reader application, which may be built into mobile computing device 204 or added by the developer. Mobile computing device 204 may also include screen 208 via which mobile computing device 204 displays to the user application-related options and screens. In one example, screen 208 may be a touch screen that allows interaction by user's touch via user's finger or a device (e.g., stylus pen).

When the user captures the image of the computer-generated image, as shown in FIG. 2A, the captured image may be displayed on display 208. Mobile computing device 204 may employ a processor to execute an algorithm that determines, based on the captured image, that the captured image is of a barcode. The algorithm may subsequently launch the reader application, which is capable of decoding the captured image of the computer-generated image. The reader application may determine, based on the decoded information contained in the computer-generated image, to launch an appropriate application, e.g., a browser to display a URL or markup language encoded in the computer-generated image, as shown in FIG. 2B.

In one example, mobile computing device 204 may have more than one platform for running the application encoded in the computer-generated image, e.g., more than one type of browser for displaying web-based elements or applications. In this example, the reader application, upon decoding the information in the captured computer-generated image may provide a list of the different platforms associated with the application. The user, e.g., the developer, may then select one of the platforms to test the application. Subsequently, the user may return to the list of platforms and select another platform in which to test the application.

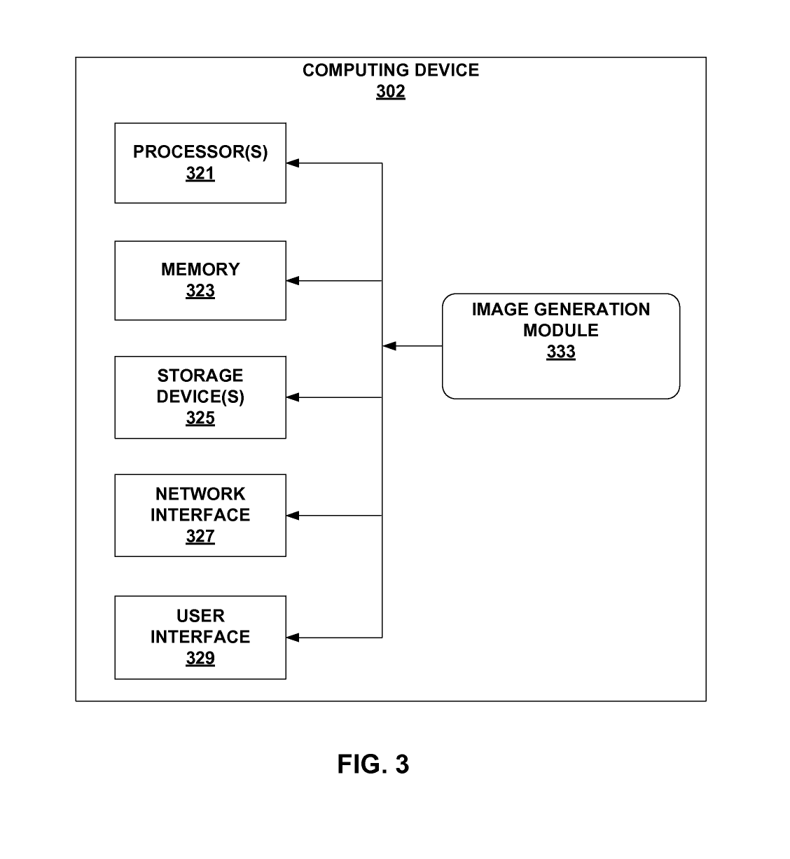

FIG. 3 is a block diagram illustrating further details of one example of the computing device 102 shown in FIG. 1. FIG. 3 illustrates only one particular example of computing device 302, and many other example embodiments of computing device 302 may be used in other instances. Computing device 302 may be a desktop computer or a workstation, for example, which a developer may use to develop applications for computing devices. As shown in the example of FIG. 3, computing device 302 includes one or more processors 321, memory 323, one or more storage devices 325, a network interface 327, and user interface 329. Each of components 321, 323, 325, 327, and 329 may be interconnected via one or more busses for inter-component communications. Additionally, computing device 302 may include applications and modules associated with additional functionalities computing device 302 executes and runs, e.g., image generation module 333.

Processors 321 may be configured to implement functionality and/or process instructions for execution within computing device 302. Processors 321 may be capable of processing instructions stored in memory 323 or instructions stored on storage devices 325. In one example, processor 321 may execute algorithms and instructions associated with image generation module 333 to implement techniques of this disclosure.

User interface 329 may include, for example, a monitor or other display device for presentation of visual information to a user of computing device 302. User interface 329 may further include one or more input devices to enable a user to input data, such as a manual keyboard, mouse, touchpad, trackpad, etc. User interface 329 may further include printers or other devices to output information. In various instances in the description contained herein, references made to user interface 329 may refer to portions of user interface 329 (e.g., keyboard, screen, mouse device) that provide user input functionality.

In one example, user interface 329 may enable a user, e.g., an application developer, to develop an application by inputting code associated with the application. Computing device 302 may include resources and programs that allow the user to compile the developed code to produce the desired application in different formats (e.g., executable, markup language, URL, and the like).

Memory 323 may be configured to store information within computing device 302 during operation. Memory 323 may, in some examples, be described as a computer-readable storage medium. In some examples, memory 323 is a temporary memory, meaning that a primary purpose of memory 323 is not long-term storage. Memory 323 may also be described as a volatile memory, meaning that memory 323 does not maintain stored contents when the computer is turned off. Examples of volatile memories include random access memories (RAM), dynamic random access memories (DRAM), static random access memories (SRAM), and other forms of volatile memories known in the art. In some examples, memory 323 may be used to store program instructions for execution by processors 321. Memory 323 may be used by software or applications running on computing device 302 (e.g., image generation module 333) to temporarily store information during program execution.

Storage devices 325 may also include one or more computer-readable storage media. Storage devices 325 may be configured to store larger amounts of information than memory 323. Storage devices 325 may further be configured for long-term storage of information. In some examples, storage devices 325 may comprise non-volatile storage elements. Examples of such non-volatile storage elements may include magnetic hard discs, optical discs, floppy discs, flash memories, solid state discs (SSDs), or forms of electrically programmable memories (EPROM) or electrically erasable and programmable (EEPROM) memories.

Computing device 302 also includes network interface 327. Computing device 302 may utilize network interface 327 to communicate with external devices (e.g., one or more servers, web servers, other computing devices) via one or more networks. The network interface 327 allows computing device 302 to connect to a network for which network interface 327 is configured. In one example, network interface 327 may implement limitations on connectivity of computing device 302 for security reasons, e.g., to prevent a user from exporting sensitive and proprietary information residing on computing device 302.

Computing device 302 also includes image generation module 333. A developer of an application may utilize computing device 302 to develop an application or portions of an application intended, for example, for use on mobile computing devices. The developer may wish to test the developed application or portions of the application on one or more mobile computing devices. In one example, the developer may utilize image generation module 333 to encode the application or portions of the application that the developer wishes to test.

Encoding the application or portions of the application may include converting the portions to a different format (e.g., executable, markup language, URL, and the like) and generating a computer-generated image (e.g., QR code) that encodes the application, as discussed above. The computer-generated image may be stored in memory 323 and/or storage device(s) 325. In one example, the developer may utilize network interface 327 to communicate the computer-generated image or information encoded in the computer-generated image (e.g., the URL, executable, markup language, and the like) to a mobile computing device for testing purposes.

In one example, network interface 327 may not be available, or the corresponding network interface on the mobile computing device may not be available, e.g., broken, unsupported, misconfigured, crippled, incompatible, unavailable, or generally disabled. In this example, the developer may utilize another method to transfer the encoded application or portions of application to the mobile computing device. In one example, the developer may utilize user interface 329 to display and/or output a physical copy of the computer-generated image. The developer may utilize the computer-generated image to test the encoded application or portions of the application on one or more mobile computing devices, platforms, operating systems, and the like, as part of testing of the application. For example, for web-based applications, the developer may wish to test mobile rendering of web-based elements of an application to ensure that different platforms, operating systems, and mobile computing devices render the elements correctly.

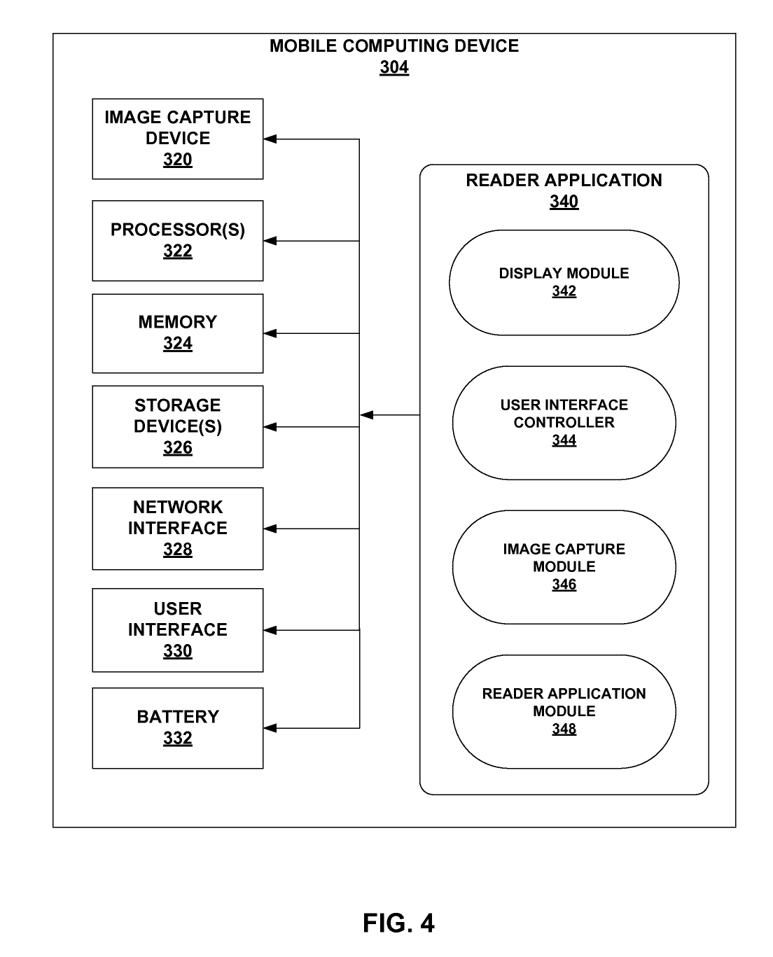

FIG. 4 is a block diagram illustrating further details of one example of the mobile computing device shown in FIGS. 2A-2B. FIG. 4 illustrates only one particular example of mobile computing device 304, and many other examples of mobile computing device 304 may be used in other instances. In one example, several instances of mobile computing device 304 may be utilized by a developer of an application, as explained above, to test compatibility of a developed applications or portions of the application with different mobile computing devices, platforms for running the application (e.g., web browsers), operating systems, and the like.

As shown in the example of FIG. 4, mobile computing device 304 includes one or more processors 322, memory 324, one or more storage devices 326, a network interface 328, user interface 330, and battery 332. Each of components 322, 324, 326, 328, 330, and 332 may be interconnected via one or more busses for inter-component communications. Processors 322 may be configured to implement functionality and/or process instructions for execution within mobile computing device 304. Processors 322 may be capable of processing instructions stored in memory 324 or instructions stored on storage devices 326.

User interface 330 may include, for example, a monitor or other display device for presentation of visual information to a user of mobile computing device 304. User interface 330 may further include one or more input devices to enable a user to input data, such as a manual keyboard, mouse, touchpad, trackpad, etc. In some examples, user interface 330 may comprise a touchscreen, which may be used both to receive and process user input and also to display output information and application-specific options. User interface 330 may further include printers or other devices to output information. In various instances in the description contained herein, references made to user interface 330 may refer to portions of user interface 330 (e.g., keyboard, touch screen, mouse device) that provide user input functionality.

Memory 324 may be configured to store information within computing device 300 during operation. Memory 324 may, in some examples, be described as a computer-readable storage medium. In some examples, memory 324 is a temporary memory, meaning that a primary purpose of memory 324 is not long-term storage. Memory 324 may also be described as a volatile memory, meaning that memory 324 does not maintain stored contents when the computer is turned off. Examples of volatile memories include random access memories (RAM), dynamic random access memories (DRAM), static random access memories (SRAM), and other forms of volatile memories known in the art. In some examples, memory 324 may be used to store program instructions for execution by processors 322. Memory 324 may be used by software or applications running on mobile computing device 304 (e.g., reader application) to temporarily store information during program execution.

Storage devices 326 may also include one or more computer-readable storage media. Storage devices 326 may be configured to store larger amounts of information than memory 324. Storage devices 326 may further be configured for long-term storage of information. In some examples, storage devices 326 may comprise non-volatile storage elements. Examples of such non-volatile storage elements may include magnetic hard discs, optical discs, floppy discs, flash memories, solid state discs (SSDs), or forms of electrically programmable memories (EPROM) or electrically erasable and programmable (EEPROM) memories.

Mobile computing device 304 also includes network interface 328. Mobile computing device 304 may utilize network interface 328 to communicate with external devices (e.g., one or more servers, web servers, other computing devices) via one or more networks (e.g., a wireless network, a cellular network). The network interface 328 allows mobile computing device 304 to connect to one or more networks for which network interface 328 is configured.

Mobile computing device 304 also includes image capture device 320. Various applications may utilize image capture device 320, where image-capturing capabilities may be needed. In one example, image-capturing capabilities may be utilized by mobile computing device 304 to scan in and read computer-readable or computer-generated images such as, for example, those generated by image generation module 333 of FIG. 3A.

Any applications implemented within or executed by mobile computing device 304 (e.g., reader application 340) may be implemented or contained within, operable by, executed by, and/or be operatively coupled to processors 322, memory 324, storage device 326, network interface 328, and/or user interface 330.

One example of reader application 340 is shown in FIG. 4. Reader application 340 may include a display module 342, a user interface controller 344, an image capture module 346, and a reader application module 348. Reader application 340 may include image capture module 346, which controls image capture device 320 to scan in and read computer-readable or computer-generated images, such as barcodes, as discussed above. Reader application 340 may be stored in memory 324 and/or storage devices 326, and may be operable by processors 322 to perform various tasks during execution.

In one example, during implementation or execution of reader application 340, image capture module 346 may be operable by processors 322 to capture an image. Display module 342 may be also operable by processors 322 to display the image captured by the image capture module, as shown in FIG. 2A, for example. Image capture module 346 may be capable of detecting whether the captured image is a computer-generated image such as, for example, a QR code as shown in FIG. 2A. Reader application module 348 may be launched by processors 322 if image capture module 346 determines that a captured image is a computer-generated image. Reader application module 348 may be operable by processor 322 to decode an image determined to be a computer-generated image and launch an application corresponding to the information encoded in the computer-generated image. Reader application module 348 may decode the computer-generated image to determine the information contained therein, and launch the appropriate application. For example, if the computer-generated image contains a URL or markup language (i.e., a web-based application or web-based elements of an application), reader application module 348 may launch a web browser to display the content corresponding to the URL or markup language.

User interface controller 344 may be operable by processors 322 to display information to the user. For example, user interface controller 344 may display a web browser with the content corresponding to the information encoded in a computer-generated image. User interface controller 344 may also display a message to the user (e.g., the developer) if, for example, mobile computing device 304 supports more than one platform corresponding to the information encoded in the computer-generated image. For example, if mobile computing device 304 supports two or more types of web browsers, user interface controller 344 may display a list of the available browsers for the user to select from to launch and display the content corresponding to the information encoded in the computer-generated image.

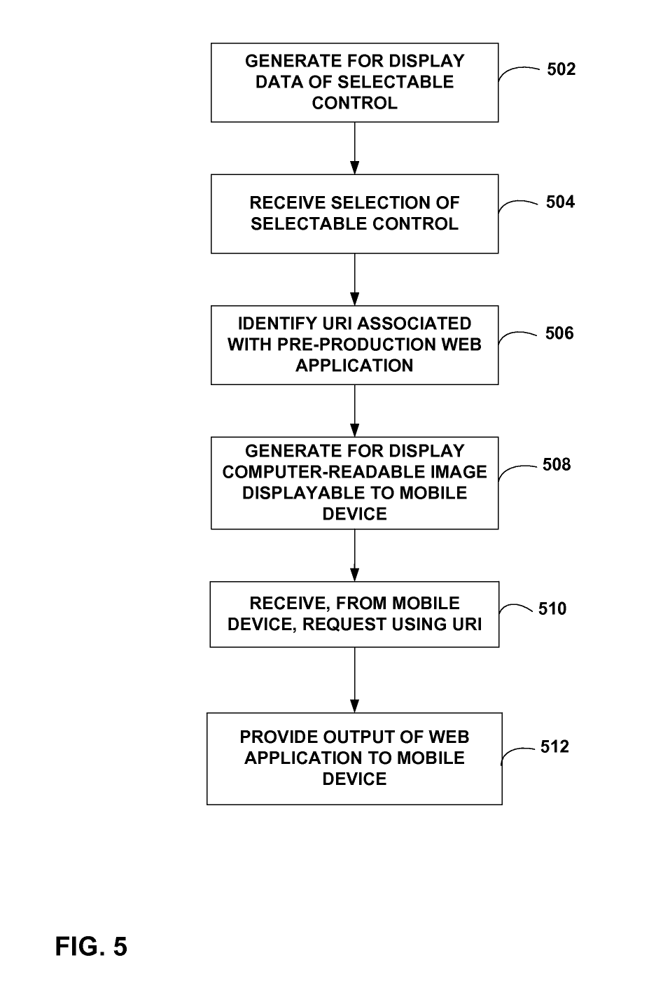

FIG. 5 is a flow diagram illustrating an example method that may be performed by a computing device in accordance with one or more technique of the present disclosure. For example, the illustrated example method may be performed by computing device 202 (FIGS. 2A-2B) or computing device 302 (FIG. 3). In some examples, a tangible and/or non-transitory computer-readable storage medium (e.g., a medium included in storage device 325, memory 323) may be encoded with instructions that, when executed, cause one or more processors (e.g., processor 321) to perform one or more of the acts illustrated in the method of FIGS. 2A-2B, and 3.

The method of FIG. 5 includes generating for display, data corresponding to a selectable control (502). In some examples, the selectable control may be associated with a web application at a pre-production stage of development. Additionally, selection of the selectable control may cause the computing device to generate a computer-readable image that encodes a uniform resource identifier (URI) associated with the pre-production web application. The selectable control may, in some examples, be presented as an interactive web element. Selection of the selectable control (e.g., by a user) may be accomplished by interacting with some or all of the selectable control. In one implementation, a user may perform the selection by clicking on only a portion of the selectable control, such as an image provided within the selectable control (e.g., using a mouse, touchpad, stylus, finger, etc.). In another implementation, the user may perform the selection by interacting with the entire selectable control. For example, the computing device may generate the selectable control to be an interactive button (provided by hypertext markup language, etc.). In this example, the user may perform the selection by selecting the entire selectable control (namely, the button).

The pre-production web application may, in some examples, represent a web application that is being tested for performance, display, etc. before being made accessible over the Internet (e.g., by a developer or other related parties). In these examples, the selectable control may be displayable in association with output of the pre-production web application. For example, the computing device may use the selectable control to solicit user action to generate a computer-readable image associated with the pre-production web application. Upon selection of the selectable control, the computing device may generate computer-readable image such that the computer-readable image encodes the URI associated with the pre-production web application. The URI may include a URL associated with the pre-production web application, e.g., in instances where the pre-production web application is accessible within a local area network, etc.

The method further receiving, by the computing device, a selection of the selectable control (504). As described with respect to step 502, selection of the selectable control may occur in several ways, including user interaction with some or all of the selectable control. The method further includes identifying the URI associated with the pre-production web application (508). The computing device may, for example, identify the URI in order to access data associated with or included in the pre-production web application. The method further includes generating for display a computer-readable image that is displayable to a mobile computing device (508). As discussed, a mobile computing device, such as a mobile phone, may be equipped to scan, photograph, or otherwise capture computer-readable images, such as QR codes, barcodes, and UPCs. Additionally, a mobile computing device may use the computer-readable image (e.g., by decoding the image) to obtain encoded data, such as the URI associated with the pre-production web application. Based on the obtained URI, the mobile computing device make a request to the pre-production web application, such as by using the URI to locate the application, and transmitting the request accordingly.

The method further includes receiving, by the computing device from the mobile computing device, the request that uses the URI (510). Before sending the request, the mobile computing device may have previously captured and used the computer-readable image to obtain the URI. The method further includes providing, by the computing device, output of the pre-production web application to the mobile device, responsive to the request (512). The computing device may provide the output such that the mobile computing device displays the output. For example, the mobile computing device may be configured to display the output using one or more web browsers installed on the mobile computing device.

In some examples, the computing device may receive requests from multiple mobile computing devices. For instance, the computing device may receive a second request from a second mobile computing device. In this example, the computing device may also provide the output to the second mobile computing device, responsive to the second request. In various scenarios, the second mobile computing device may run a second operating system (different from a first operating system running on the first mobile computing device), a second web browser (different from a first web browser running on the first mobile computing device), and otherwise vary from the first mobile computing device. In some examples, the pre-production web application may include, be, or be part of a mobile web-based application.

In some examples, the pre-production web application may be a standalone web application. In instances where the pre-production web application is a standalone web application, the output, as displayed by the mobile computing device, the pre-production web application may form the entirety of a display. For example, the pre-production web application may occupy the entire area provided by a web browser running on the mobile computing device. In other examples, the pre-production web application may be part of a targeted webpage displayed by the mobile computing device. A targeted webpage may include elements generated by targeting various criteria, such as the content of the pre-production web application. For example, the targeted webpage may include an advertisement. The advertisement may be based on one or more of user preferences, the content of the pre-production web application, and other criteria.

In some examples, the pre-production web application may include one or both of the selectable control and the computer-readable image. In some such examples, a production environment (e.g., the web application at a post-production stage) may not include one or both of the selectable control and the computer-readable image that were included in the pre-production web application.

When the mobile computing device receives the encoded information, it may decode the information and launch a platform capable of running the mobile application. In the example of the web-based application, the platform may be a web browser. The mobile computing device may launch a web browser to display the mobile application based on the decoded information, for example.

The method also includes generating, by the computing device, a representation of the encoded information associated with the mobile application (506). The generated representation may be, for example, a computer-readable image (such as a QR code). The mobile computing device may be capable of scanning the computer-readable image using an image capture device and a reader application, as described above in connection with FIG. 3B.

In one example, the information to be encoded in the computing-readable image may exceed a certain size, such as a standard size (e.g., a maximum number of characters) or other predefined size that can be encoded in a computer-readable image. In this example, the encoded information may be partitioned into a plurality of portions, where each portion does not exceed the standard size, and each portion may be used to generate a computer-readable image. In this example, each of the portions may include an indication that the portion is part of a set of portions. In one example, each of the portions may also include an indication of the number of portions in the set of portions, the order of the portions (and/or placement of each portion within the order) and the position of the portion within the sequence of portions. In this manner, when a mobile computing device scans the computer-readable image and decodes the information in each of the portions, the mobile computing device may determine the number of portions it should get before putting all the portions together to obtain the information associated with the mobile application.

In one example, the developer may utilize the techniques of this disclosure to debug the developed code. In the example of the web-based application, the developer may determine whether the mobile computing device renders the web-based application in a desirable manner. As such, it may be desirable to test the developed code with different types of mobile computing devices, different types of mobile operating systems, and different types of platforms (e.g., different types of web browsers). The developer may utilize the same computer-readable image with one or more mobile computing devices to determine compatibility of the developed code with the one or more mobile computing devices, which may be running one or more operating systems and/or may be utilizing one or more platforms for the mobile application.

As noted above, the developer may utilize the techniques of this disclosure to debug the developed code on one or more mobile computing devices. The application being tested may be encoded using a computer-generated image, for example, and the computer-generated image may be utilized to test the application on one or more mobile computing devices. Additionally, during test of one mobile computing device, the developer may determine based on the outcome or response of the mobile computing device that alterations may be required to the application being test if, for example, the application does not exhibit an expected behavior. In this example, after the developer modifies or updates the mobile application, the same computer-generated image may be utilized to debug the updated version of the application to determine its performance based on the response or outcome of invoking the application on the mobile computing device.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, a computer-readable storage medium may comprise a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various embodiments of the disclosure have been described. These and other embodiments are within the scope of the following claims.

What is claimed is:

1. A method comprising:
generating for display, by at least one computing device, data corresponding to a selectable control, wherein
the at least one computing device provides a pre-production web application that is at a pre-production stage of development,
the selectable control is displayable in association with output of the pre-production web application, and
the selectable control, when selected, causes a computer-readable image encoding a uniform resource identifier (URI) associated with the pre-production web application to be generated;
receiving a selection of the selectable control;
identifying the URI associated with the pre-production web application;
generating for display a computer-readable image encoding the URI, wherein the computer-readable image is displayable to a mobile computing device configured to
capture the computer-readable image,
use the computer-readable image to obtain the URI,
make a request to the pre-production web application using the URI, and
display output of the pre-production web application, the output corresponding to the URI;
receiving, by the at least one computing device and from the mobile computing device, a request using the URI, the mobile computing device having previously captured and used the computer-readable image to obtain the URI; and
responsive to the request, providing, by the at least one computing device and to the mobile computing device, output of the pre-production web application corresponding to the URI,
such that the mobile computing device displays the output of the pre-production web application corresponding to the URI.

2. The method of claim 1, further comprising:
receiving, by the at least one computing device and from a second mobile computing device, a second request using the URI, the second mobile computing device having previously captured and used the computer-readable image to obtain the URI; and
responsive to the second request, providing, by the at least one computing device and to the second mobile computing device, the output of the pre-production web application corresponding to the URI, such that the second mobile computing device displays the output of the pre-production web application corresponding to the URI.

3. The method of claim 2, wherein the mobile computing device runs a first operating system and the second mobile computing device runs a second operating system that is different from the first operating system.

4. The method of claim 2, wherein the mobile computing device runs a first web browser and the second mobile computing device runs a second web browser that is different from the first web browser.

5. The method of claim 1, wherein the pre-production web application comprises a mobile web-based application, and wherein the URI includes a uniform resource locator (URL) associated with the mobile web-based application.

6. The method of claim 1, wherein generating the data corresponding to the selectable control comprises generating the data such that the data conforms to a markup language.

7. The method of claim 1, wherein providing the output to the mobile computing device comprises providing the output such that the mobile computing device displays the output at least in part by launching a web browser.

8. The method of claim 1, wherein the computer-readable image comprises at least one of a Quick Response (QR) Code, a universal product code (UPC), and a barcode, such that the mobile computing device is configured to capture the computer-readable image at least in part by scanning the computer-readable image.

9. The method of claim 1, wherein the pre-production web application forms at least a portion of a targeted webpage that includes at least one advertisement associated with the pre-production web application.

10. The method of claim 1, wherein the computer-readable image exceeds a predefined size, the method further comprising:
partitioning the computer-readable image to form a plurality of portions, wherein each portion of the plurality of portions is less than or equal to the predefined size, and wherein the mobile computing device has the capability to capture and combine the plurality of portions to obtain the computer-readable image before using the computer-readable image to obtain the URI.

11. The method of claim 10, wherein each portion of the plurality of portions of the encoded computer-readable image includes an indication of a corresponding order within the plurality of portions.

12. The method of claim 10, wherein receiving the selection of the selectable control comprises receiving a selection associated with only a portion of the selectable control.

13. The method of claim 12, wherein the portion associated of the selectable control comprises at least one of an image included in the selectable control and a web element included in the selectable control.

14. The method of claim 1, wherein the pre-production web application comprises a standalone web application, such that a web browser running on the mobile computing device displays only the standalone web application.

15. A computer-readable storage medium encoded with instructions that, when executed, cause one or more processors of at least one computing device to perform operations comprising:
receiving data including a uniform resource identifier (URI) associated with a pre-production web application, wherein the pre-production web application is at a pre-production stage of development;
generating for display a computer-readable image encoding the URI, wherein the computer-readable image is displayable to a mobile computing device configured to:
capture the computer-readable image to obtain the URI,
make a request to the pre-production web application using the URI, and
display output of the pre-production web application, the output corresponding to the URI;
receiving from the mobile computing device, a request using the URI, the mobile computing device having previously captured and used the computer-readable image to obtain the URI; and
responsive to the request, providing, to the mobile computing device, output of the pre-production web application corresponding to the URI, such that the mobile computing device displays the output of the pre-production web application corresponding to the URI.

16. The computer-readable storage medium of claim 15, wherein the operations further comprise:
receiving, from a second mobile computing device, a second request using the URI, the second mobile computing device having previously captured and used the computer-readable image to obtain the URI;
responsive to the second request, providing, to the second mobile computing device, the output of the pre-production web application corresponding to the URI, such that the second mobile computing device displays the output of the pre-production web application corresponding to the URI.

17. The computer-readable storage medium of claim 15, wherein the computer-readable image comprises at least one of a Quick Response (QR) Code, a universal product code (UPC), and a barcode, such that the mobile computing device is configured to capture the computer-readable image at least in part by scanning the computer-readable image.

18. A computing device comprising:
one or more processors; and
a display device,
wherein the one or more processors are configured to:
generate for display, at the display device, data corresponding to a selectable control, wherein
the computing device provides a pre-production web application that is at a pre-production stage of development,
the selectable control is displayable in association with output of the pre-production web application, and
the selectable control, when selected, causes a computer-readable image encoding a uniform resource identifier (URI) associated with the pre-production web application to be generated;
receive a selection of the selectable control;
identify the URI associated with the pre-production web application;
generate for display, at the display device, a computer-readable image encoding the URI, wherein the computer-readable image is displayable to a mobile computing device configured to
capture the computer-readable image,
use the computer-readable image to obtain the URI,
make a request to the pre-production web application using the URI, and
display output of the pre-production web application, the output corresponding to the URI;
receive, from the mobile computing device, a request using the URI, the mobile computing device having previously captured and used the computer-readable image to obtain the URI; and
responsive to the request, provide, to the mobile computing device, output of the pre-production web application corresponding to the URI, such that the mobile computing device displays the output of the pre-production web application corresponding to the URI.

19. The computing device of claim 18, wherein the pre-production web application forms at least a portion of a targeted webpage that includes at least one advertisement associated with the pre-production web application.

20. The computing device of claim 18, wherein the pre-production web application comprises a standalone web application, such that a web browser running on the mobile computing device is enabled to display the standalone web application without additional content.
